(19) United States
(12) Patent Application Publication
(10) Pub. No.: US 2007/0025233 A1
(43) Pub. Date: Feb. 1, 2007

(54) Information carrier having wobble pre-groove

(76) Inventor: Martinus Wllheimus Blum, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/556,518

(22) PCT Filed: Mar. 12, 2004
(86) PCT No.: PCT/IB04/50650

§ 371 Date: Sep. 5, 2006

(30) Foreign Application Priority Data
May 16, 2003 (EP) 03076488.0
Feb. 10, 2004 (EP) 04100480.5

(51) Int. Cl. G11B 7/24

(52) U.S. Cl. 369/275.4

(57) ABSTRACT

The present invention relates to an information carrier for storing user-data, said information carrier comprising a wobbled pre-groove having stored a wobble information and comprising sinusoidal wobbles. The wobble information is encoded by use of ADIP units, which are formed by sequences of sinusoidal wobbles having embedded patterns of MSK marks. In order to avoid the use of an MSK mark present at the beginning of each ADIP unit, as according to Blue-ray Disc, and the consequent wobble beat, a new set of ADIP units is introduced wherein MSK marks are disposed in patterns according to which no mark is in a common position in all the set of ADIP units. The invention further relates to a device and a method for reading the wobble information from the information carrier, and to a recording apparatus and method for recording user-data therein.

The present invention relates to an information carrier for storing user-data, said information carrier comprising a wobbled pre-groove having stored a wobble information and comprising sinusoidal wobbles. Further, the present invention relates to methods and devices for reading address information from said information carrier.

The Blu-ray Disc (ED) format is based on a method to encode addressing information in the wobble using so called MSK-cosine (MSK=minimum shift keying) marks, called MSK-marks in the following. The wobbles are grouped into so-called ADIP (Address in pre-groove) units, each 56 wobble periods long. Such an ADIP unit contains a pattern of MSK-marks, thus constructing data units and sync units. These sync units and data units together form a so called ADIP word which contains the addressing information and parity symbols to protect this information.

Detection of the MSK marks on BD is negatively affected by a phenomenon called wobble beat. Wobble beat is caused by the cross talk of the wobble in the neighboring tracks. It gives rise to an amplitude beat and a phase shift of the wobble signal in the central track This can degrade the detection of the MSK-marks on the disc.

It is an object of the present invention to provide an information carrier having a wobbled pre-groove which allows for a reliable detection of the MSK-marks. Appropriate devices and methods for reading address information from said information carrier shall also be provided.

This object is achieved according to the present invention by an information carrier as claimed in claim 1, by a device as claimed in claim 10 and by a method as claimed in claim 12.

Preferred embodiments of the invention are defined in the dependent claims.

The present invention is based on the recognition that especially on radii where the MSK-marks are almost aligned, the detection will degrade. In an ideal situation it should be prevented that two MSK-marks are written close together in neighboring tracks. In practice this is, of course, not possible and it is not a big problem when it occurs randomly. In the BD format however, each ADIP unit (independent of its type) starts with a MSK-mark, also called bit sync. Because of its regular structure the bit sync will give rise to alignment of MSK-marks on certain radii for a prolonged period. This is not a desired situation, and preferably the bit-sync should be omitted. However, it should still be possible to detect the transition between two ADIP units.

Therefore, according to the present invention an alternative to the use of bit-syncs aligned at the beginning of each ADIP unit is found in the use of predetermined patterns of marks embedded in the sinusoidal wobbles of the pre-groove which patterns of marks are indicative of both the information stored in the wobble information and the beginning of the ADIP unit. According to the invention therefore, there is no mark present in a common position in all predetermined patterns of marks of said plurality of predetermined patterns as is the case in the known patterns where a bit-sync is present in all patterns indicating the start of an ADIP unit. The patterns of marks proposed according to the invention can thus dispense bit-syncs, since they provide the same functionality, i.e. allow the reading device to detect the start of a second block and possibly, as proposed in preferred embodiments, further address information. Storage space previously occupied by bit-syncs can thus be used to encode other information, such as user-data. Further, the alignment of the patterns of marks is solved, in this way preventing detection degradation due to bit sync alignment.

In an embodiment of the invention the plurality of sinusoidal wobbles of a second block comprises a unique pattern of marks, i.e. there are a number of predetermined unique patterns of marks which can be easily detected so that each different pattern represents a different kind of information, for instance a certain address information such as an address bit or an address byte.

Furthermore, each pattern of marks may comprise an equal number of marks. This is advantageous from a detection point of view, i.e. it is known to a reading device how many MSK-marks belong to a pattern of marks to decode a certain information stored therein.

In particular, the number of marks of each pattern may be three and, preferably, each second block comprises 56 sinusoidal wobbles. In a further embodiment, based on the BD format, and in particular for an intended format called Portable Blue, the second block is an ADIP unit and the pattern of marks is a pattern of MSK-marks.

It is further preferred, that the position of the marks in the predetermined patterns of marks are selected such that any sequence of two second blocks does not include any pattern of said plurality of predetermined patterns across the boundary between said two second blocks. Thus, any two second blocks put together do not form an existing pattern on their boundaries. It can be further foreseen that there are different groups of predetermined patterns and that patterns in a first group have a large distance, for instance at least 2, to all other patterns while patterns in the other group have a lower distance of at least 1. Thus, patterns of the first group have a higher probability of correct detection than patterns from the second group.

In an even further embodiment of the invention it is proposed that the first block comprises a fixed number of second blocks, wherein in a first group of said second blocks the pattern of marks is predetermined and in a second group of said second blocks address information is encoded by selecting appropriate patterns from said plurality of patterns of marks. Thus, for instance, so-called ADIP words can be formed by use of a predetermined number of different ADIP units where a first group of ADIP units is fixed representing some kind of synchronization of ADIP words while in a second group an address information can be encoded by selection of appropriate ADIP units.

In particular, the second group of said second blocks address information is encoded by selecting appropriate patterns from a group of patterns of marks, contained in said plurality of patterns of marks, which group comprises at least three patterns of marks, and in particular 16 patterns of marks, implying that each of the second can represent up to four address information bits.

In a further embodiment, the second block represents a plurality of address information bits, so that address information can be stored with a higher density in the wobbled pre-groove, allowing among other things for a higher addressing rate.

The invention will now be explained in more detail with reference to the drawings in which

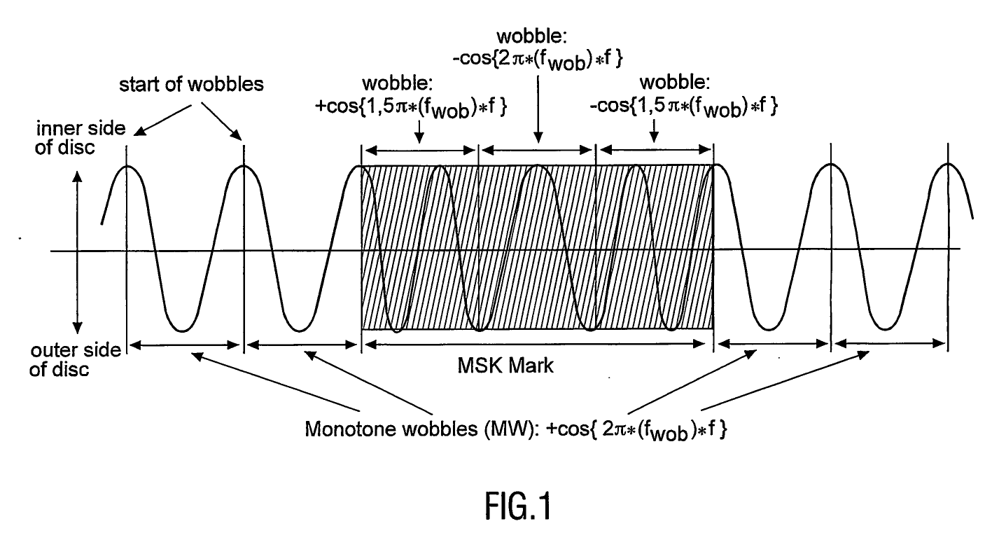

FIG. 1 illustrates the principle of MSK-cos modulation according to BD,

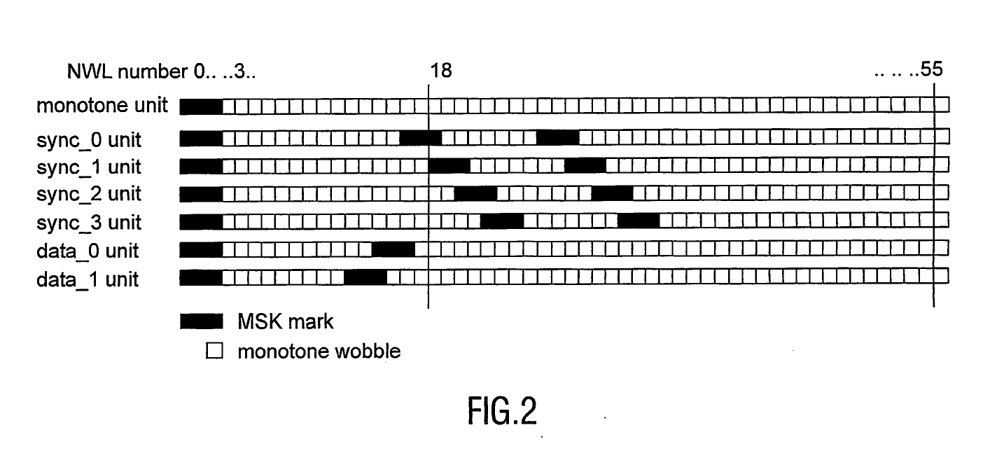

FIG. 2 illustrates ADIP unit types according to BD,

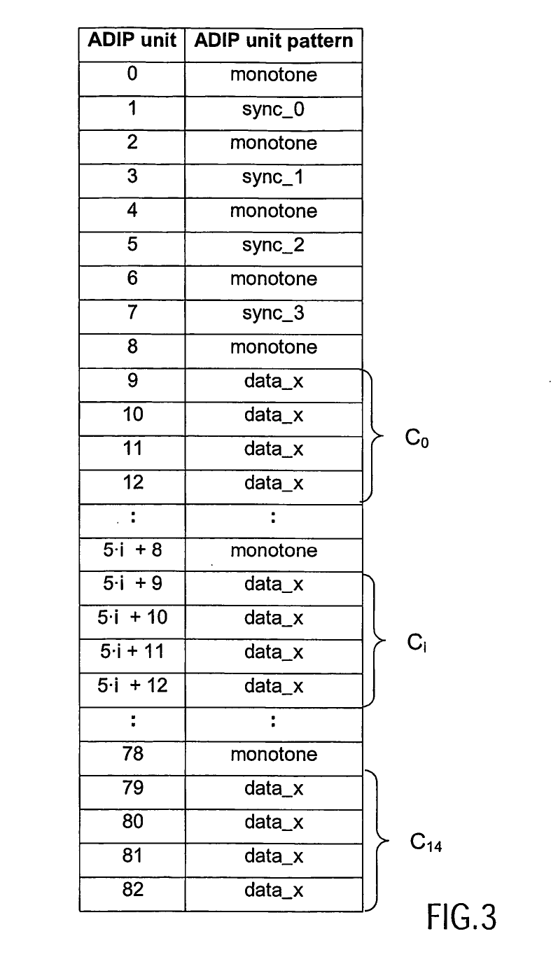

FIG. 3 shows the ADIP word structure as used in BD,

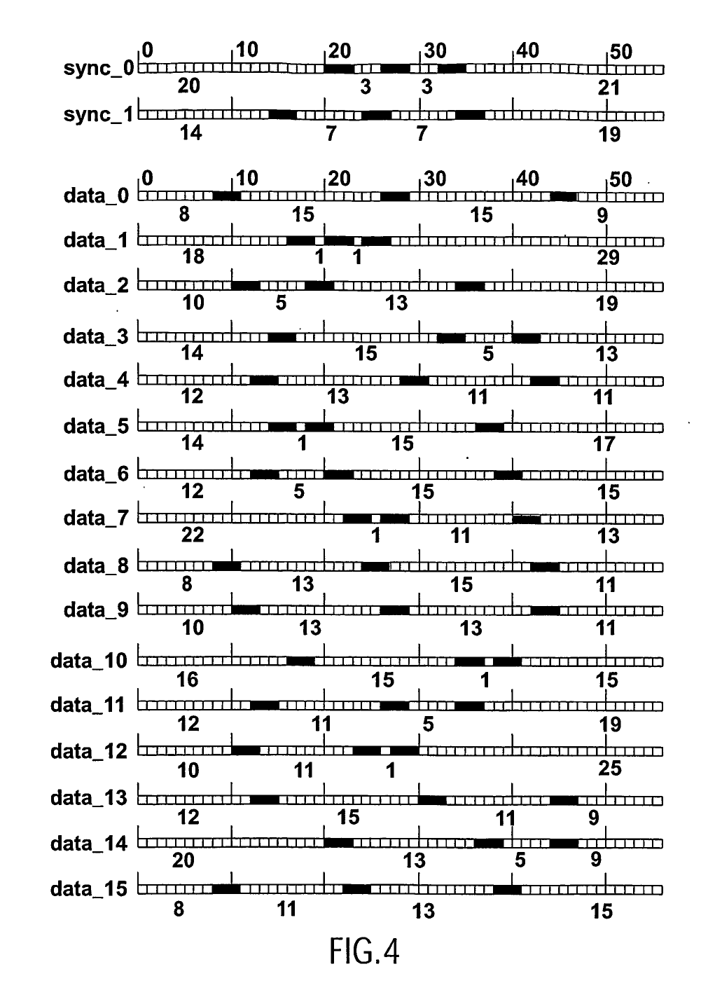

FIG. 4 shows ADIP unit types according to a preferred embodiment of the present invention, and

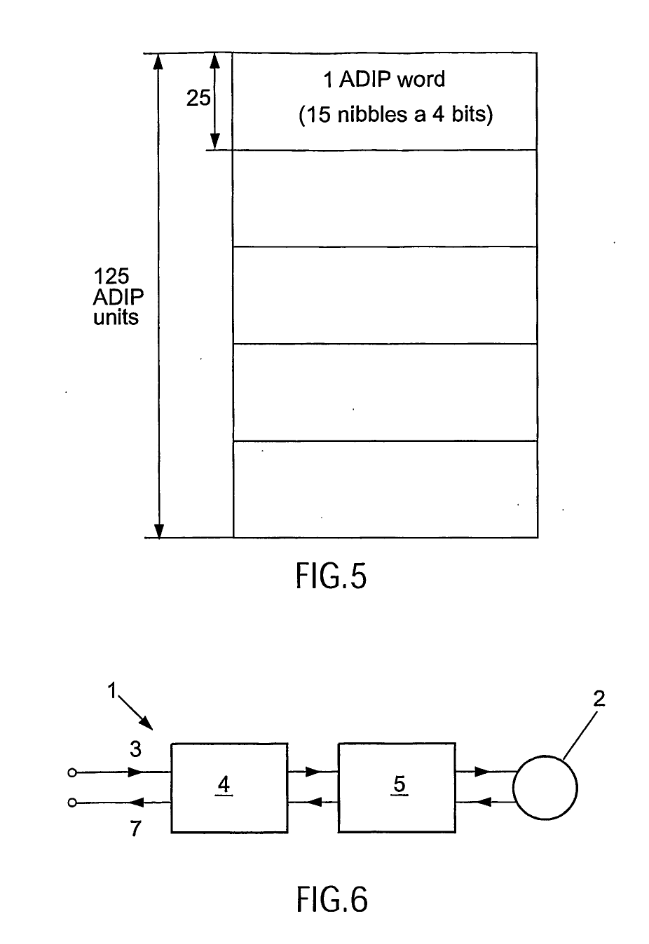

FIG. 5 shows the structure of a recording unit block according to the preferred embodiment of the invention, and

FIG. 6 shows a block diagram of an apparatus according to the invention.

FIGS. 1, 2 and 3 show an MSK mark, 8 different ADIP unit types, and the ADIP word structure built upon these 8 different ADIP unit types, according to the BD standard.

As it can be seen, an ADIP word is 83 ADIP units or 166 frames long. The choice of this number is closely related to the structure of an ECC block (which is 498 frames long including run-in and run-out fields). For Portable Blue (PB) a different error correction format is chosen, which has a length of 250 frames including run-in and run-out fields. The ADIP format should be adapted to fit this new length.

According to the preferred embodiment, the invention is applied to an optical disc of a new format intended for portable devices and derived from the BD standard. In particular the new format has the followings aspects in common with BD standard:
The wobble period is 69T. One frame of 1932 channel bits is equivalent to 28 wobbles.
The ADIP information is encoded using MSK-cos modulation.
Informed decoding error correction format is used (with the addition of Gray-encoding of the addresses, as described in WO 03/017499-A2, corresponding to Philips Patent Application NL010600), a method (as described in WO 02093754-A1, corresponding to Philips Patent Application NL010331) that allows to enhance the error correcting capabilities on an error correcting code if some of the information symbols are known to the decoder.

However, the new format differs from BD standard in that a Recording Unit Block (RUB) is 250 frames long, 248 for the ECC block and 2 for the run-in and the run-out field, with 32 kilobyte of user-data per ECC block. So the length of an RUB is 250×28=7000 wobbles. Based on this, there are two options to divide an RUB into an integer number of ADIP units:
1. 125 units×56 wobbles (equivalent to 2 frames, like the Blu-ray format)
2. 100 units×70 wobbles

Approximately one RUB fits on one circumference on the inner radius (6 mm) of a Portable Blue disc. There should be somewhere between 4 and 8 addresses per revolution (rough estimation). Furthermore, to enable power saving, the addressing rate needs to be increased compared to the Blu-ray Disc standard In this format 18 bits are used to count the RUBs. Since each RUB can store 32 kilobytes of user-data, a total storage capacity of 2¹⁸ ×32×1024=8.6 GB can be addressed in each layer. This is sufficient for small form factor optical discs for which this embodiment is meant to be used.

In the preferred embodiment ADIP units of 56 wobbles each are chosen, which gives 125 ADIP units per RUB.

Preferably, according to the invention there are 18 different types of ADIP units:
2 sync units (sync_0 and sync_1)
16 data units (data_0-data_15). A data unit represents four bits: data_0 represents ‘0000’, data_1 ‘0001’, data_2 0010’ etc.

The 18 ADIP unit types are shown in FIG. 4. They have the following properties which enable a robust detection:
Each ADIP unit contains a unique pattern of 3 MSK-marks
The sync units have a distance of 2 to all other units (both sync and data)
The data units have a mutual distance of at least 1. When in bit-lock (i.e. the location of the ADIP unit boundaries is known), the data units have a mutual distance of at least 2.
Two arbitrary ADIP units put together do not form an existing data or sync pattern on their boundaries (the gap between the patterns is at least 17, the longest gap between two MSK-marks in any data pattern is 15).
Detection of one of the patterns will give exact information on the location of the start of the ADIP unit
When in bit-lock data_0 to data_4 have a mutual distance of 3.

In context of this application the term “distance” can be seen as the inverse of the similarity between two patterns: the larger the similarity between two patterns, the smaller their distance. In this case, the distance between two patterns can be defined in two different situations:

1) Not taking into account the position of the pattern within the ADIP unit To determine the distance between two patterns, they can be placed on top of each other in an arbitrary position such that there are as many overlapping marks as possible. The distance is said to be zero when all marks overlap. The distance is said to be one when there is always at least one non-overlapping mark. The distance is said to be two when there are always at least two non-overlapping marks and so on.

2) Taking into account the position of the pattern within the ADIP unit To determine the distance between two patterns, the ADIP units corresponding to these patterns are placed on top of each other. Like in the previous situation, the distance is said to be zero when all marks overlap. The distance is said to be one when there is one non-overlapping mark and so on.

It should be noted that in the case when there are 3 marks per ADIP unit, the largest possible distance is two in the first situation and three in the second situation.

According to this embodiment of the invention there is no bit-sync, like there is in the Blu-ray disc formal or like it is used in the ADIP units shown in FIG. 2. This is to eliminate the worst case situation: bit-syncs That (almost) align in neighboring tracks because the circumference is an integer number of ADIP units. Instead the ‘bit-sync’ is stored implicitly. Each pattern of three MSK-marks has a fixed position within the ADIP unit. Therefore the detection of a pattern also means that the start of the ADIP unit, i.e. the bit-sync position, is known.

The 125 ADIP units of 1 RUB unit, as used in a preferred embodiment of the invention, are divided into 5 blocks of 25 units each. Each of these blocks contains an ADIP word, which in turn consists of 15 nibbles of 4 bits each (c₀, c₁, . . . , c₁₄). Such a division of an RUB unit is shown in FIG. 5.

The ADIP word structure is shown in the following table:

| | |
|---|---|
| 0 | sync_0 |
| 1 | data_0 |
| 2 | data_x (c₀) |
| 3 | data_x (c₁) |
| 4 | data_x (c₂) |
| 5 | sync_1 |
| 6 | data_1 |
| 7 | data_x (c₃) |
| 8 | data_x (c₄) |
| 9 | data_x (c₅) |
| 10 | sync_1 |
| 11 | data_2 |
| 12 | data_x (c₆) |
| 13 | data_x (c₇) |
| 14 | data_x (c₈) |
| 15 | sync_1 |
| 16 | data_3 |
| 17 | data_x (c₉) |
| 18 | data_x (c₁₀) |
| 19 | data_x (c₁₁) |
| 20 | sync_1 |
| 21 | data_4 |
| 22 | data_x (c₁₂) |
| 23 | data_x (c₁₃) |
| 24 | data_x (c₁₄) |

The ADIP word (c₀ to c₄) is a Reed-Solomon codeword, formed by encoding 9 information nibbles (n₀ to n₈) with a non-systematic Reed-Solomon code. This RS-code is the informed decoding RS-code as it is used in Blu-ray, but with the addition of a Gray-encoder.

The bit assignments of the information nibbles no to n8 is as follows:

| nibble | bit 3 | bit 2 | bit 1 | bit 0 | | |
|---|---|---|---|---|---|---|
| n₀ | AA23 | AA22 | AA21 | AA20 | ↑ | ADIP |
| n₁ | AA19 | AA18 | . | . | 6 nibbles | address |
| | | | . | . | | |
| | | | . | . | | |
| . | . | . | . | . | | |
| . | . | . | . | . | | |
| . | . | . | . | . | | |
| n₅ | AA3 | . | . | AA0 | ↓ | |
| | | . | . | | | |
| | | . | . | | | |
| n₆ | AX11 | . | . | . | ↑ | AUX data |
| | | . | . | . | | |
| | | . | . | . | | |
| . | . | . | . | . | 3 nibbles | |
| . | . | . | . | . | | |
| . | . | . | . | . | | |
| n₈ | AX3 | . | . | AX0 | ↓ | |
| | | . | . | | | |
| | | . | . | | | |

AA23 . . . AA0: Layer number
AA20 . . . AA3: RUB number
AA2 . . . AA0: Address sequence number inside the RUB (0 . . . 4)
AX11 . . . AX0: Auxiliary data. Used in the run-in to store the disc information.

Further embodiments of the invention include the following variations:
ADIP units of 70 wobbles, providing 100 ADIP units per RUB which can be divided into 5 groups of 20 units. With a redefinition of the ADIP units (at least one extra sync unit), also 5 addresses per RUB can be stored. The advantage of this embodiment is that there are less MSK-marks per RUB. The disadvantages are that a maximurn likelihood decoder becomes approximately 25% larger (the patterns become longer and there are 70 instead of 56 positions that require evaluation) and the data frames do not align with the ADIP units.
6 addresses per RUB. This gives 6 groups of 20 units and 5 remaining units. It requires at least one extra sync, which can only be generated when the sync patterns do not require a mutual distance of 2. Furthermore, there should be ‘stuffing’ units for the 5 remaining ADIP units (for instance a group of sync units).
7 addresses per RUB. This gives 7 groups of 17 units and 6 units remaining. A group can store 15 nibbles and two syncs per ADIP word. Also in this case stuffing is required for the remaining units.
more than 8 addresses per RUB. This requires that less nibbles per address are stored. This could, for instance, be achieved by leaving out AUX nibbles and/or parity nibbles.

FIG. 6 schematically shows the main elements of an apparatus 1 according to the invention, capable of storing user-data on and reading user-data from an information carrier 2, such as an optical disc. The apparatus 1 comprises a processing unit 4 which, at an input 3, is provided for receiving user-data to be stored on the information carrier 2. The processing unit 4 mainly performs encoding and modulation of the user-data into codewords which are sent to reading/writing means 5 for being written on the information carrier 2.

Further, the processing unit 4 comprises decoding and demodulation means for decoding and demodulating codewords and the sinusoidal wobbles read by the reading/writing 5 from the information carrier 2 into respectively user-data provided to an output 7 and wobble information.

In the information carrier 2, the pre-groove is provided with a plurality of sinusoidal wobbles into which a wobble information, in particular an addressing information is stored. According to the preferred embodiment of the invention, the wobble information is encoded by use of the ADIP units shown in FIG. 4.

Before and during writing user-data on the disc, or also while reading user-data from the disc, the sinusoidal wobbles of the pre-groove are detected by the reading/writing means 5, and the wobble information stored in the detected wobbles, e.g. an address information, is decoded by appropriate decoding means included in the processing unit 4.

Although the invention has been elucidated with reference to an optical disc, in particular based on BD format, it will be evident that other embodiments may be alternatively used to achieve the same object. The scope of the invention is therefore not limited to the embodiments described above, but can also be applied to other kinds of information carriers or to the transmission of information.

It must further be noted that the term “comprises/comprising” when used in this specification, including the claims, is taken to specify the presence of stated features, integers, steps or components, but does not exclude the presence or addition of one or more other features, integers, steps, components or groups thereof. It must also be noted that the word “a” or “an” preceding an element in a claim does not exclude the presence of a plurality of such elements. Moreover, any reference signs do not limit the scope of the claims; the invention can be implemented by means of both hardware and software, and several “means” may be represented by the same item of hardware. Furthermore, the invention resides in each and every novel feature or combination of features.

The invention can be summarized as follows. The present invention relates to an information carrier for storing user-data, said information carrier comprising a wobbled pre-groove having stored a wobble information and comprising sinusoidal wobbles. The wobble information is encoded by use of ADIP units, which are formed by sequences of sinusoidal wobbles having embedded patterns of MSK marks. In order to avoid the use of an MSK mark present at the beginning of each ADIP unit, as according to Blue-ray Disc, and the consequent wobble beat, a new set of ADIP units is introduced wherein MSK marks are disposed in patterns according to which no mark is in a common position in all the set of ADIP units. The invention further relates to a device and a method for reading the wobble information from the information carrier.

1. Information carrier (2) for storing user-data, said information carrier comprising a wobbled pre-groove having stored wobble information and comprising sinusoidal wobbles, said wobble information comprising a first block including address information, said first block comprising at least one second block, said second block being formed by a plurality of said sinusoidal wobbles, said plurality of sinusoidal wobbles comprising marks disposed in a pattern of marks belonging to a plurality of predetermined patterns of marks, said patterns of marks allowing for the determination of the start of said second block and none of the marks being in a common position in said plurality of predetermined patterns of marks.

2. Information carrier (2) as claimed in claim 1, wherein said pattern of marks is a unique pattern of marks within said plurality of predetermined pattern of marks.

3. Information carrier (2) as claimed in claim 1, wherein each pattern of marks comprises an equal number of marks.

4. Information carrier (2) as claimed in claim 3, wherein said equal number of marks is three.

5. Information carrier (2) as claimed in claim 1, wherein said second block is an ADIP unit and wherein said pattern of marks is a pattern of MSK-marks.

6. Information carrier (2) as claimed in claim 1, wherein the positions of the marks in said predetermined patterns of marks are selected such that any sequence of two second blocks does not include any pattern of said plurality of predetermined patterns across the boundary between said two second blocks.

7. Information carrier (2) as claimed in claim 1, wherein said first block comprises a fixed number of second blocks, wherein in a first group of said second blocks the pattern of marks is predetermined and in a second group of said second blocks address information is encoded by selecting appropriate patterns from said plurality of patterns of marks.

8. Information carrier (2) as claimed in claim 7, wherein in said second group of said second blocks address information is encoded by selecting appropriate patterns from a group of patterns of marks, contained in said plurality of patterns of marks, which group comprises at least three patterns of marks, and in particular 16 patterns of marks.

9. Information carrier (2) as claimed in claim 1, wherein said second block represents a plurality of address information bits.

10. Device for reading address information stored in the pre-groove of an information layer of an information carrier (2), comprising: detection means (5) for detecting a plurality of sinusoidal wobbles in the pre-groove, and decoding means (4) for decoding wobble information stored in said detected plurality of wobbles, said wobble information comprising a first block including the address information, said first block comprising at least one second block, said second block being formed by a plurality of said sinusoidal wobbles, said plurality of sinusoidal wobbles comprising marks disposed a pattern of marks belonging to a plurality of predetermined patterns of marks, said patterns of marks allowing for the determination of the start of said second block and none of the marks being in a common position in the plurality of predetermined patterns of marks.

11. Recording apparatus (1) comprising a device as claimed in claim 10 and storing means for storing user-data in the pre-groove of the information layer of the information carrier (2).

12. Method of reading address information stored in the pre-groove of an information layer of an information carrier (2), comprising the steps of: detecting a plurality of sinusoidal wobbles in the pre-groove, and decoding wobble information stored in said detected plurality of wobbles, said wobble information comprising a first block including the address information, said first block comprising at least one second block, said second block being formed by a plurality of said sinusoidal wobbles, said plurality of sinusoidal wobbles comprising marks disposed a pattern of marks belonging to a plurality of predetermined patterns of marks, said patterns of marks allowing for the determination of the start of said second block and none of the marks being in a common position in the plurality of predetermined patterns of marks.

13. Method of recording user-data in an information carrier (2) comprising the steps present in the method as claimed in claim 12, and further comprising the step of storing information in the pre-groove of the information layer of the information carrier.
